(19) United States
(12) Patent Application Publication
(10) Pub. No.: US 2006/0083276 A1
(43) Pub. Date: Apr. 20, 2006

(54) Cryogenically cooled solid state lasers

(75) Inventor: David C. Brown, Brackney, PA (US)

Correspondence Address: DAVID C. BROWN, 3440 BRITTAN RD., BRACKNEY, PA, 18812, US

(73) Assignee: Snake Creek Lasers, LLC.

(21) Appl. No.: 10/951,027

(22) Filed: Sep. 28, 2004

(51) Int. Cl. H01S 3/04

(52) U.S. Cl. 372/36; 372/35

(57) ABSTRACT

Methods and constructions for cryogenically cooled solid state lasers are provided that allow the cooling channels to be embedded within the heat sinks used to conductively cool the laser medium. Several gain medium geometries are disclosed that are compatible with efficient and straight forward cryogenic cooling techniques using practical pump chamber designs while eliminating the need for the pump light to traverse the cryogenic layers and allowing for smooth temperature cycling. A number of active material configurations that can be generally adapted for pumping by high power diodes—including slab, thin disk, active mirror and rod geometries—are shown to be compatible with the cryogenic cooling approaches of the invention. Modeling results based on the preferred cooling configurations indicate substantial improvement in the performance of common solid state lasers, including Nd and Yb-doped lasers.

The present application claims the benefit of priority from commonly assigned U.S. patent application Ser. No. 60/505,054, filed Sep. 24, 2003.

### BACKGROUND OF THE INVENTION

1. Field of the Invention

The present invention relates generally to laser systems and more specifically to cryogenically-cooled solid-state lasers and techniques for practical realizations of high average power lasers.

2. Description of Related Art

Solid-state lasers can be diode-pumped, flashlamp-pumped, or pumped by another laser source. Regardless of the pumping technique, almost all solid-state lasers operating at high-average-power are susceptible to thermal distortions resulting from the optical-pumping process. As shown in publications to T. Y. Fan (see “Heat Generation in Nd:YAG and Yb:YAG”, IEEE J. Quantum Electron. 29, 1457-1459, 1993) and D. C. Brown (in IEEE J. Quantum. Electron. 34, 560-572, 1998), the sources of heat in typical optically-pumped laser materials can be attributed to several sources, in particular, non-radiative “dead sites”, non-unity quantum efficiency between the pump and metastable (upper) laser levels, non-radiative multi-phonon decay from the metastable level to the ground state, upconversion, excited-state absorption, non-radiative multi-phonon decay from the terminal laser level to the ground state, as well as spontaneous-emission processes. While the details of the heating contributions from each effect vary from material to material, the resulting internal heating of the lasing material leads to the formation of thermal gradients. Thermal gradients lead, in turn, to changes in the index of refraction of the laser material, and in most cases of high-average-power operation to significant phase distortion of a laser beam. In addition, when thermal gradients are severe, significant stresses and strains are induced in the elastic laser material and these result in strain-induced distortion of surfaces traversed by the laser beam, thereby further degrading the output beam quality. Ultimately, when critical surfaces are subjected to sufficiently high stress levels, thermally-induced rupture (fracture) of the laser material can occur. Such material fracture, which is known to first be initiated at polished or ground surfaces where scratches, voids, and defects reduce the materials' strength to levels that can be well below the intrinsic values, represents the upper limit on power scaling of solid state lasers.

Many methods have been suggested over the years to ameliorate the thermal effects in solid-state lasers. One approach was to alter gain medium geometry, for example, to a rectangular slab, in which optical beams are zig-zagged back and forth to compensate for the thermal gradient in a laser medium and eliminate thermally-induced focusing, at least to first-order. See for example U.S. Pat. Nos. 5,900,967, 6,134,258 and 6,268,956 for various zigzag slab laser configurations that were face, side and end-pumped, respectively. Alternative slab configurations described in the art dispensed with the zigzag approach, opting instead for straight-through beam propagation path, wherein heat was effectively dissipated through a thin transverse dimension. One especially promising thin slab design was described in a recent U.S. Patent Application 20030138021 to Hodgson et al. In this implementation, a slab of crystalline laser material such as Nd or Yb-doped YAG is sandwiched between two Cu or sapphire heat sinks with cooling channels running through them parallel to the slab length. In this example, the slab was optically-pumped through the edges, allowing complete separation of the functions of heat removal, pumping, and extraction (one to each axis). The thin slab geometry is expected to be highly effective in maintaining a uniform temperature profile and therefore phase distortion profile across the slab width and thickness. The principal drawbacks of the thin slab design were an asymmetric output beam profile—which requires additional optics to correct and power output limitations due to heat dissipation limits.

Similar thermal gradient compensation methods were applied to active-mirror amplifier configurations and even to rod amplifiers, as was described, for example, by Brown in U.S. Pat. No. 6,115,400. An alternative geometry involved designs wherein the beam propagation takes place in the direction of the thermal gradient. This is the principle of the face-pumped, face-cooled laser configuration which has been demonstrated for a variety of lasers, including diode-pumped Nd:YVO₄ lasers (see for example D.C. Brown et al in Appl. Opt., 36, 8611, 1997) and, has more recently been successfully applied to power scale “thin-disk” amplifiers (which are similar to thin active mirrors) as was taught for example in U.S. Pat. Nos. 5,53,088, 6,438,152 and 6,577,66 among others. It is worth noting here, that thin disks (like active mirrors) architectures can be pumped from the side or from the face but in contrast with the slab geometry, the beam propagation and heat removal directions are co-axial.

In the simplest cases, thermally-induced wavefront distortions in a rod amplifier are spherical in nature owing to the quadratic dependence of the radial thermal profile. In many prior art designs, this feature led to the application of simple lenses to try to negate such distortions. Similarly, cylindrical lenses were employed in slab lasers to correct for any residual distortions. In addition, the strain-induced distortion of the end faces in a rod or slab amplifier could be, for the most part, eliminated by bonding undoped “end-caps” that onto each end traversed by the extracting beam passes as was described by Meissner and McMahon in U.S. Pat. No.5,563,899 and by Meissner et al in U.S. Pat. No. 5,936,984. It has been found experimentally however that attempts to compensate thermal distortion with such relatively simple compensation methods become increasingly problematic as average power is scaled up. Reasons for the difficulties in fully compensating distortions by straightforward optical means include the fact that the induced thermal lens can be very thick or is distributed, precluding full compensation by a single external lens and the known variability of laser materials properties with temperature, which can be significant. Alternative wavefront compensation techniques involved adaptive-optic mirrors and phase conjugation. However, whereas such techniques were successfully applied to reduce thermally induced aberrations in solid-state amplifiers, they were effective mostly in cases where the aberrations are residual or relatively mild. Furthermore, most adaptive optic solutions employed to date involved complex designs which could be quite expensive to implement, with the cost increasing in proportion to the size of the aberrations to be corrected. Still other alternatives known in the art of high power lasers, focused on minimizing or eliminating the sources of heating altogether, for example, by selecting an active ion with smaller quantum defect such as Yb:YAG for which the heat fraction has been measured to be less than about 11%. Unfortunately, the Yb ion is a quasi-three-level system at room temperature, requiring brighter diodes to overcome the threshold, thereby significantly complicating pumping requirements at high powers.

Yet another approach to reducing and nearly eliminating thermal aberrations in solid-state laser materials is to operate the laser in a temperature regime where the materials properties are more favorable. The potential benefits of this approach were described for example in a series of papers by the present inventor (see D. C. Brown in IEEE, J. Quantum Electron., 33, 861, 1997, and ibid 34, p. 2383 and 2393) as well as in U.S. Pat. No. 6,195,372. In particular, with the methods taught in Pat. No. 6,195,372 it was shown that by cooling the material YAG (yttrium-aluminum-garnet) from room temperature (297° K) to the vicinity of 77° K resulted in a significant increase in the thermal conductivity and a major decrease in the thermal expansion coefficient and the change in index of refraction with temperature (dn/dT). The change in the thermal conductivity with temperature is shown in FIG. 1 derived from the aforementioned prior art publications to Brown, where the thermal conductivity at 77° K was shown to increase by about a factor of about 7 over the room temperature value. Further decreasing the temperature close to that of liquid He would result in another increase of an order of magnitude. In the present application we will however, concentrate, on the temperature region around 77° K corresponding to (liquid nitrogen or LN₂) because of the ready availability of inexpensive LN₂, and the fact that there are already commercial closed-cycle coolers that can reach that temperature region.

The literature also provides data indicating the dependence of the thermal expansion coefficient and dn/dT on temperature, indicating again the benefits of operating at lower temperatures. For example, FIG. 2 and FIG. 3 show results of recent measurements of the thermal expansion coefficient and dn/dT, respectively as a function of temperature (data taken from Appl. Opt. 3282, 1999). Thus, FIG. 2 shows that the magnitude of the thermal expansion coefficient at 77 K is reduced by about 4 times as compared with the value at room temperature, whereas FIG. 3 indicates that dn/dT is lower by a factor of 12 between room temperature and 77° K. The strong variation in the value of these parameters as a function of temperature provides the rational behind the teachings by Brown that cooling Nd:YAG to 77° K results in substantially lower thermal gradients for the same heat load. Indeed, since the thermal gradient in either a rod or slab, for example, is inversely proportional to the thermal conductivity, it will be lower by nearly a factor of 7 at 77° K than at room temperature. Furthermore, the smaller thermal expansion coefficient result in considerably lower thermally-induced stress levels at 77° K as compared to room temperature. Thus, the reduced thermal gradient and thermally-induced stress, coupled with the much smaller thermally-reduced change in index of refraction combine to substantially lower thermally-induced distortion as the temperature is reduced to near cryogenic levels, even at very high pump power levels. Being able to operate a laser with no thermal distortion and very small stress levels means that considerable improvement to a laser's beam quality can be obtained just by cooling from room temperature, or else, significantly higher pump and average powers may be achieved at cryogenic temperatures before risk of fracture induced by heating. Moreover, strain-induced distortion of flat optical surfaces is also known vanishes at cryogenic temperatures, thus further compounding the benefits of operating at low temperatures.

In addition to the thermo-mechanical properties of YAG, the optical and lasing properties of materials like Yb:YAG also become more favorable at low temperature. Thus, Yb:YAG lasing takes place between the metastable Al level of the ²F_{5/2} manifold to the Z3 level of the ground state ²F_{7/2} manifold. At temperatures around 77 ° K, it is known that the quasi-three-level material Yb:YAG, which has ground-state absorption at room temperature (of about 4.2%), becomes a true four-level system with ground-state absorption reduced to about 10⁵%, because the Boltzmann population of the ground state effectively vanishes. This means that the laser threshold is substantially lowered and that the overall laser efficiency is improved. At room temperature, Yb:YAG must be pumped with high power density (typically a few kW/cm³) to achieve transparency in the laser material. Operating at such high power densities can translate into reductions in the laser efficiency. The present inventor has also recently demonstrated in experiments with Yb:YAG that the stimulated-emission cross-section at 1029 nm (the lasing wavelength) increases by a factor of almost 2, leading to more efficient energy extraction. The broad absorption band in Yb:YAG at around 941 nm also remains broad at 77° K and thus allows the use of relatively broad (3-5 nm) bandwidth and relatively inexpensive diode arrays for optical pumping. This translates into more optimal pump absorption efficiencies especially when coupled with the observation that the absorption cross-section at 941 nm also increases somewhat at lower temperatures. For Yb:YAG, however, it is a key to cryogenic cooling that commercially available low density or lower brightness diode arrays can be employed for pumping the material. This can lead to a significant decrease in the cost and complexity of the diode arrays as well as the amplifier pump chambers, thereby significantly improving the prospects for scaling of laser output into the 100 kW-1 MW power range. For example, in the case of Yb:YAG pumped at 941 nm, using commonly available diode arrays with 45% efficiency, calculations indicate that the wall plug efficiency (laser power out divided by electrical input power to the diode arrays) of a cryogenically-cooled laser system can be as large as 30%, resulting in a substantial reduction in the number of diode arrays and the power supplies and coolers needed to drive the laser. With the continuing improvement in diode array technology to achieve higher array efficiencies, selected batches of diode arrays now produce 50-55% efficiency and further improvements may be expected in the near-future, putting efficiencies in the range of 33-37% in the realm of possibility for a high power Yb:YAG laser system.

The improvements in performance obtainable by utilizing cryogenic cooling are expected to apply to other laser materials as well. For the scientifically and commercially important Ti:Al₂O₃ (Ti sapphire) laser, for example, the thermal conductivity is known to increase from about 0.35 to 11.0 W/(cm-° K) when going from room temperature to 77° K, and the thermal expansion coefficient is reduced by a factor of 2, allowing power scaling of existing laser pumped Ti:sapphire systems by about an order of magnitude, while maintaining beam quality. For the common Nd:YAG, potential improvements in power output engendered by cryogenic cooling are also substantial, exceeding by more than a factor of 20 the levels demonstrated in room temperature operation, regardless of the geometry used for the gain material. The laser performance may be further enhanced given some evidence that the Nd:YAG material quantum efficiency may be also increased by operating at 77° K (see for example, P. D. Devor et al in IEEE J. Quantum Electron. 25, 1863, 1989).

However, while the existing art may anticipate many of the above advantages and benefits many of the more practical aspects of the cooling structure and techniques of implementing cryogenically cooled lasers complexity, have not been well addressed in any of the previous teachings. In particular, the method of pumping an amplifier by passing pump light through optically clear layer of cryogenic fluid, such as LN2, as was described in U.S. Pat. No. 6,195,372 has a number of disadvantages, including non-uniformities, due to circulating liquid turbulence, contamination issues and potentially problematic transitions between high and low temperature due to the rupture modulus.

There is therefore a need to provide constructions suitable for cryogenic cooling that are not dependent on the gain medium geometry, can be applied to many different media and geometries and are not overly complex. There is a further need to provide cooling structures that are compatible with power scaling of solid state lasers to the kilowatt level and beyond, while maintaining high beam quality. Finally, the efficiency of cooling techniques needs to be addressed since high laser efficiency at low temperatures may be offset by poor pump chamber constructions and cooling loop inefficiencies.

### SUMMARY OF THE INVENTION

It is accordingly an object of the present invention to provide techniques and constructions for cryogenically cooling solid state lasers which are highly efficient, straight forward to implement and are compatible with different types of laser geometries and amplifier system architectures.

Unlike prior art in which optical pumping of the laser medium was accomplished by passing the pump light through an optically clear layer of cryogenic fluid, typically LN₂, the present invention discloses techniques wherein cryogenic cooling is implementing without traversing the pump light through the cryogenic layer. It is therefore a key aspect of the invention that pump chamber, and pump geometries be selected such that cooling channels are embedded in the heat sinks used to cool the pump diode arrays and the laser medium. As a result, the construction of the pump chamber is considerably simplified and results in a package that is sufficiently cost effective to be commercially realizable.

In still another object of the invention, the cooling approach allows a smoother transition from room temperature to the much lower cryogenic operating temperature. This can be accomplished by circulating the cryogenic fluid through the heat sink located adjacent to the laser materials to be cooled. With the heat sink material selected such that it has good properties at cryogenic temperatures, reductions in temperatures may be accomplished with only an inconsequential temperature rise due to the thermal resistance of the heat sink.

In yet another object of the invention, the cryogenic cooling approach can be adapted to cool different laser configurations, including slabs, thin disks and rods. For scaling to high powers, it is preferred that the laser medium be side, edge- or end-pumped so as to allow beam extraction from a scalable amplifier chain.

A further understanding of the nature and advantages of the invention will become apparent by reference to the remaining portions of the specification and drawings.

### BRIEF DESCRIPTION OF THE FIGURES

FIG. 1 shows the Thermal Conductivity of Nd:YAG as a function of temperature (data taken from literature).

FIG. 2 shows the Thermal Expansion Coefficient of YAG as a function of temperature (data taken from literature)

FIG. 3 shows dn/dT of YAG as a function of temperature (data taken from literature).

FIG. 4: is a box diagram showing, generically the key components of a Diode-Pumped Solid State Laser System.

FIG. 5 is a schematic showing a cryogenic conduction cooled thin disk edge-pumped laser system for use with the present invention.

FIG. 6 is a schematic showing one configuration of stacked thin disks that are cryogenically cooled according to the present invention.

FIG. 7 is a schematic showing one configuration of an edge pumped slab laser that is cryogenically cooled according to the present invention.

### DETAILED DESCRIPTION

Throughout this patent application we refer to the “cryogenic region” as that corresponding to temperatures below about 175° K, or about −100° C. Useful cryogenic fluids in this region are liquid methane, oxygen, argon, air, nitrogen, neon, and He with normal boiling points of 111.7, 90.18, 87.28, 78.9, 77.35, 27.09, and 4.22° K respectively. Most of the embodiments described below use LN₂ as the cooling fluid, but it is understood that alternative fluids may be used, if required.

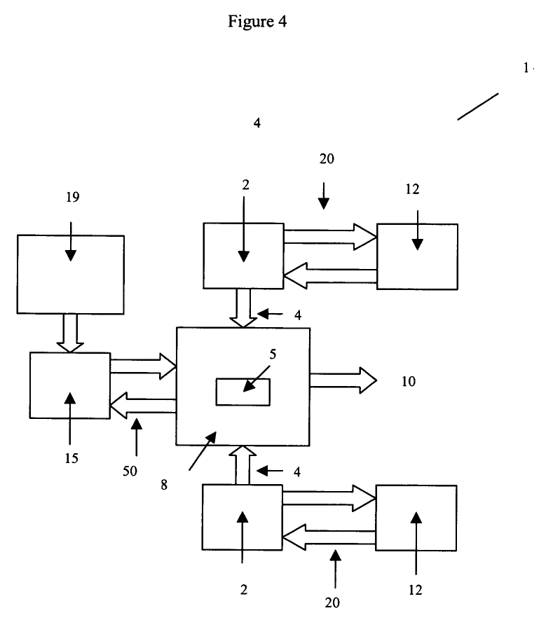

Refering now to FIG. 4, the key elements of a generic cryogenically-cooled solid-state laser system are shown. A laser medium 5 is contained in a pump chamber 8 and is pumped by light 4 from diode arrays, collectively designated as 2, producing output beam 10. A diode cooling system 12 is separately cooling the diode arrays as shown by cooling loop arrows 20. The diode arrays are most often maintained at room temperature and cooled using room temperature water cooling systems, but they may be cooled to below room temperature, depending on lifetime and power requirements using means that are generally known in the art of diode pumped lasers. The cryogenic fluid maintained at a reservoir 19 is delivered to the pump chamber 5 through cryogenic cooling system and pump 15. The fluid is then returned to the cryogenic cooling and circulation system as shown by reverse circulation arrows 50.

It is understood that the cooling systems may operate as closed or open cycle. In the former case the cryogen is re-circulated and reused using a combination of heat exchangers and compressors. In an open cycle system a cryogen is stored and delivered on demand to cool the laser; the liquid cryogen is ultimately converted to a cool gas that is then vented to the atmosphere, in some cases after the cool gas is used to further increase the laser efficiency.

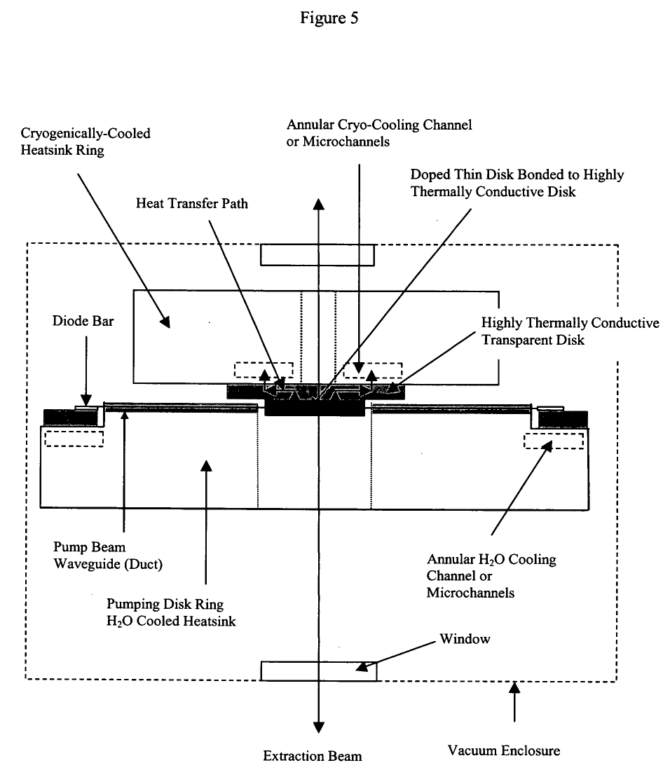

FIG. 5 shows a preferred embodiment of a conductively-cooled cryogenic solid-state laser, where the lasing medium is configured as a thin disk. The device consists of two circular rings, one on which a pre-determined number of diode pump bars are mounted and cooled with H₂O at or near room temperature, and the second ring containing a thin solid-state laser disk in contact with a high thermal conductivity disk such as sapphire or diamond which is in turn in contact with a heat sink which is cooled by the circulation of LN₂ or any other liquid cryogen. The thin disk ring protrudes into the pump ring and is optically pumped along the disk edge; light from diode bars is efficiently transmitted to the thin disk edge using a one light duct for each diode bar. The light duct may be fabricated from fused silica or sapphire for example, and is shaped to produce the desired distribution of light at the thin disk edge. It is preferably anti-reflection (AR) coated on each end at the pump wavelength and may have evanescent coatings applied to the top or bottom (or both faces) to allow the duct to be contacted to the heatsink. Diode bars may be mounted on metallic sub-mounts and then placed on the pump ring, or attached directly to the ring; cooling water removes diode heat through the use of cooling channels or by using microchannel cooling under each bar. It has a through hole in the center to allow an extracting beam to pass through.

The cryogenically-cooled ring also has a through hole in the center which is covered by a transparent larger diameter highly thermally conductive disk such as sapphire or diamond which is bonded to the thin disk using any of a number of methods. The use of a highly thermally conductive disk allows heat from the lower conductivity thin disk (doped with a laser ion) to be rapidly transmitted to the cryogenically-cooled heatsink with only minimal radial thermal gradients. This unique feature of this new amplifier geometry is made possible by the observation that the thermal conductivity of materials like sapphire and diamond, already quite large at room temperature when compared to ordinary laser materials like Yb:YAG or Nd:YAG, becomes enormous at cryogenic temperatures. Because the radial thermal gradients in the thermally conductive disk are so small, and the lower thermal conductivity thin disks are contacted directly, heat removal from the thin disk is essentially in the direction of beam propagation and has only a residual effect while the transverse thermal gradient in the thermally conductive disk may be ignored. Using this amplifier geometry, very high average power can be obtained while thermally-induced phase aberrations and birefringence are nearly eliminated. It should be pointed out that using this configuration, straight-through propagation can be obtained using the thin disk geometry, making simple linear resonator configurations possible. Previous room-temperature attempts to scale up the thin disk laser have been stymied because they need to be directly in contact with an opaque metallic material, and the use of thin film coatings on the disk side facing the heatsink reduced the efficiency of heat removal. Also, because conventional thin disk amplifiers rely on a total reflection of the amplified beam from the rear face in contact with the heatsink, “dog-leg” or off-axis resonator must be used which are often impractical to implement in real-world situations and linear resonators are impractical altogether.

The laser amplifier shown in FIG. 5 must be enclosed in a vacuum tight enclosure with windows used to get the extracting beam in and out. This is primarily because of the need to eliminate water condensation, however, the vacuum also effectively thermally isolates the cool thin disk ring from the room temperature pump ring, although in the future the diode pump ring may also be run at cryogenic temperatures to increase diode array efficiency.

Lasers built using the cryogenically-cooled thin disk geometry shown in FIG. 5 can be scaled up in power by increasing the disk diameter, increasing the number of diode bars, and by adding additional thin disks to the laser.

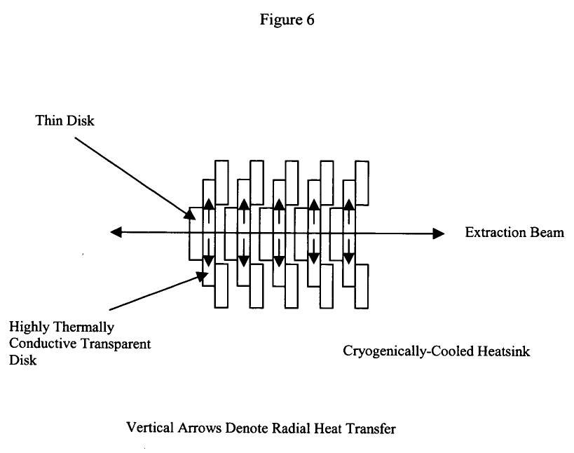

FIG. 6 shows an implementation of the cryogenically-cooled thin disk idea where a plurality of thin disk/transparent highly conductive disk assemblies are arranged in close proximity to each other, limited only by the physical dimensions of the disk assembly holders. This configuration is reminiscent of early attempts to build “zero-axial gradient” solid-state lasers using a liquid flowing between the individual disk assemblies, but where here the cooling fluid is replaced with the highly thermally conductive disk substrate that is cryogenically-cooled. As in the previous case shown in Figure A, heat from each individual disk is transferred to the conductive substrate it is mounted on and then ultimately to the flowing liquid cryogen loop in the heatsink. This geometry may be attractive for making super compact high average power solid-state lasers, and scaling the average power is accomplished by increasing the number of disks or the disk diameter and number of diode bars.

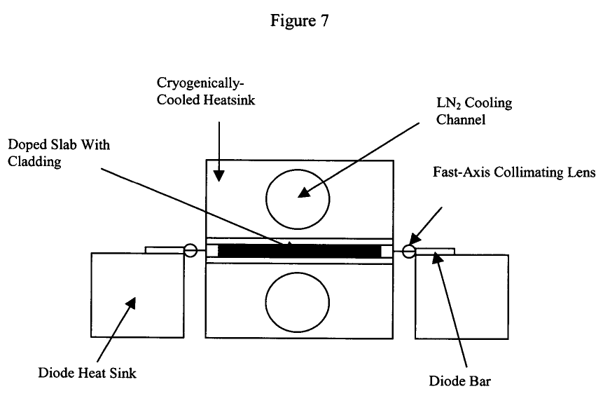

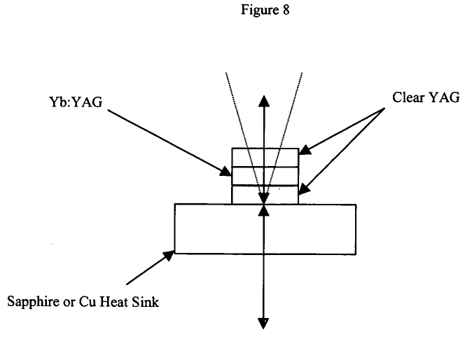

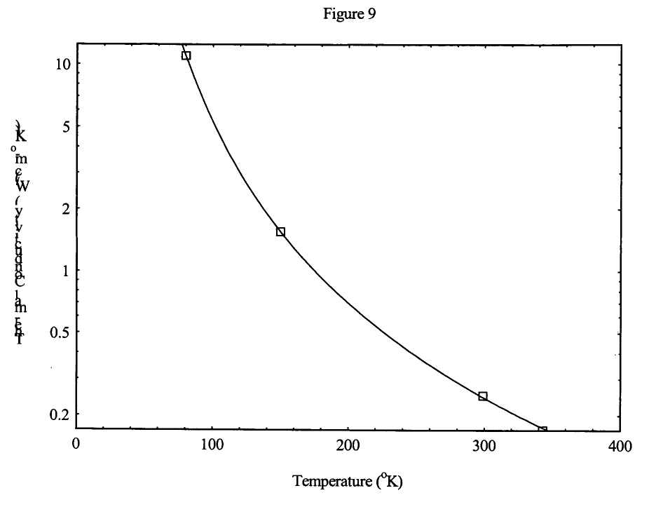

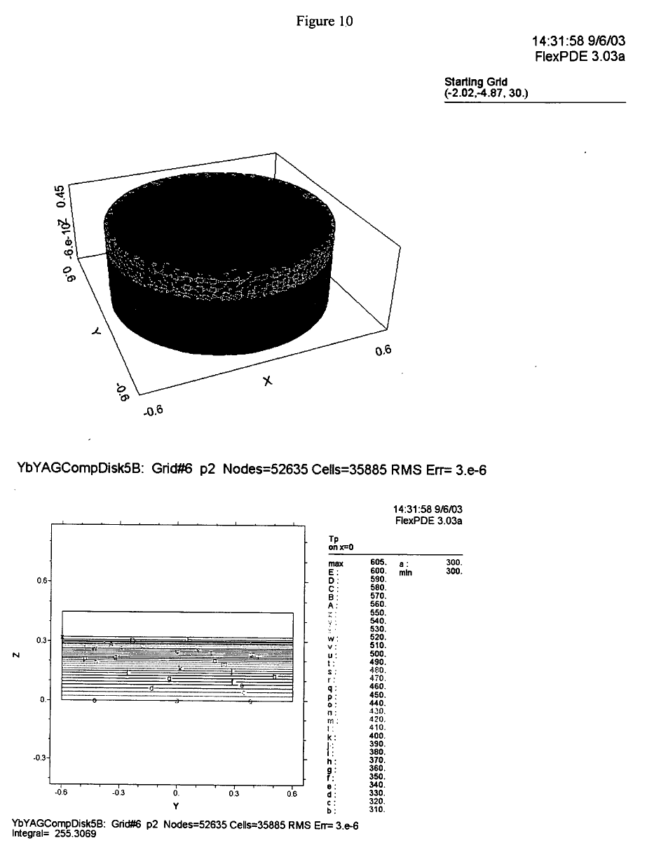

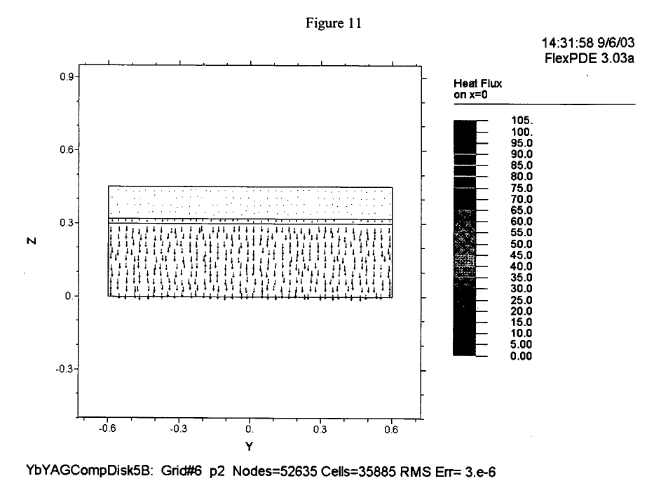

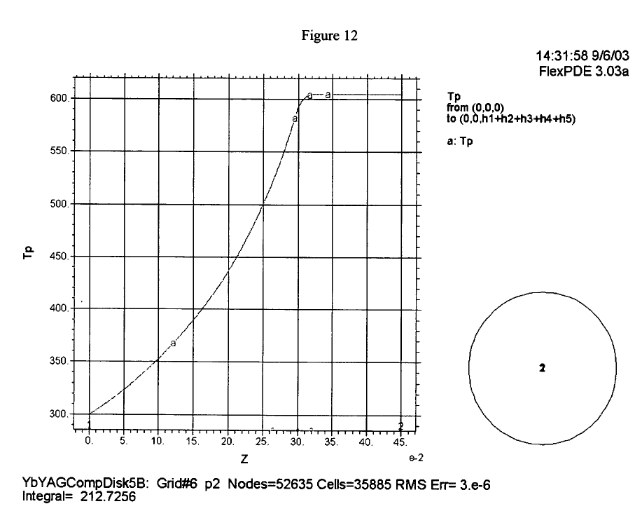

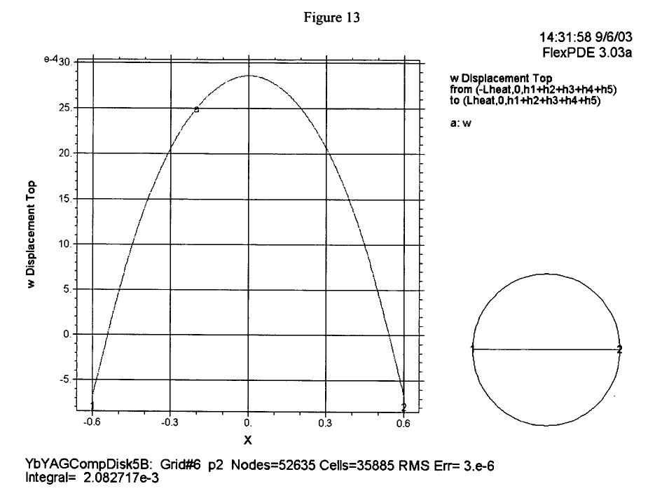

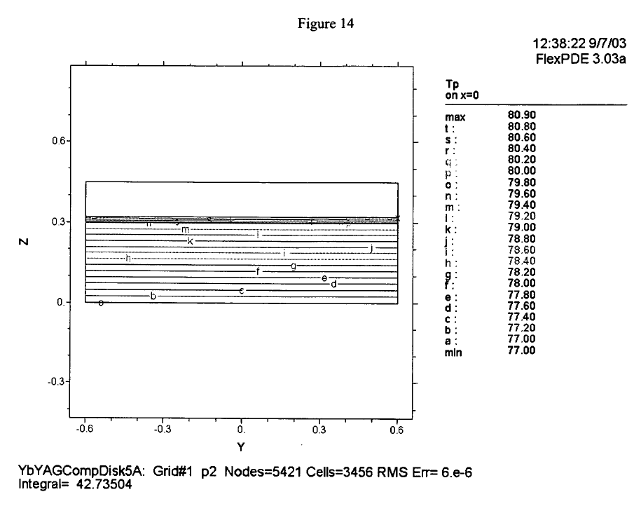

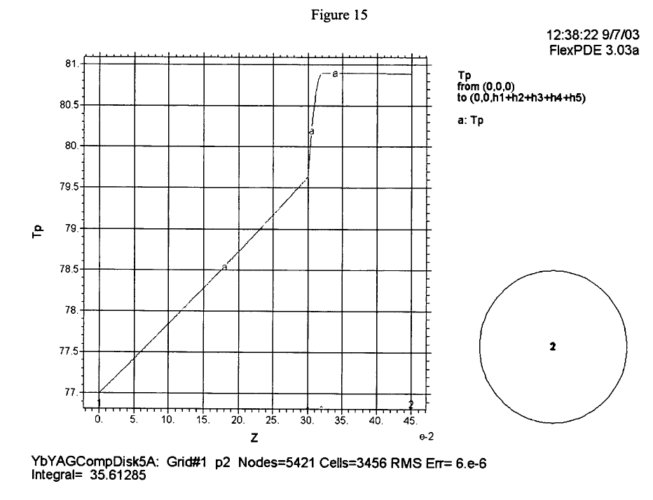

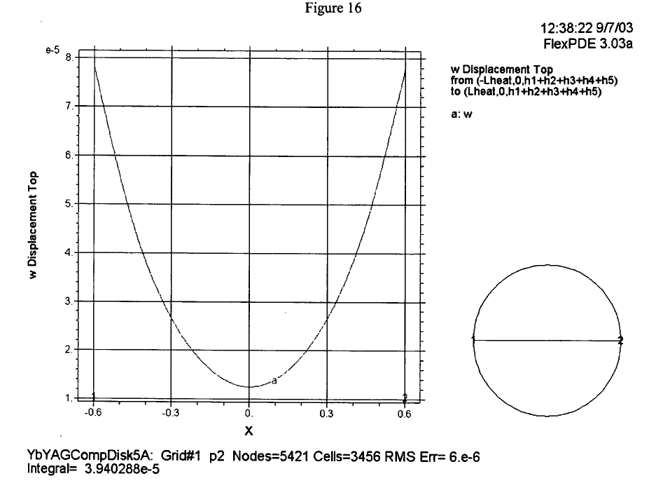

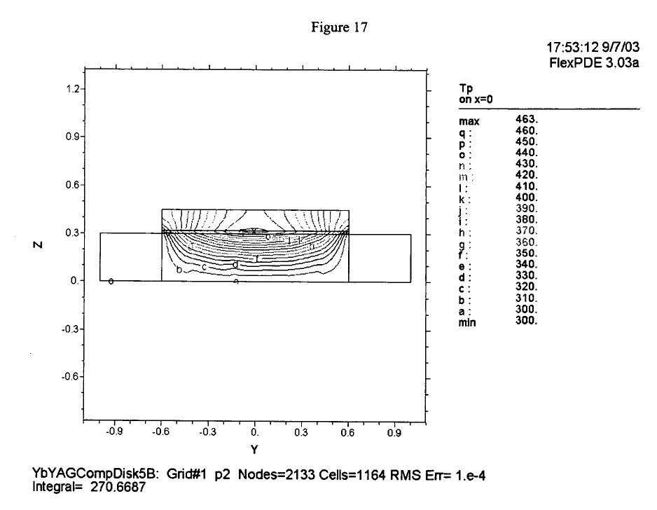

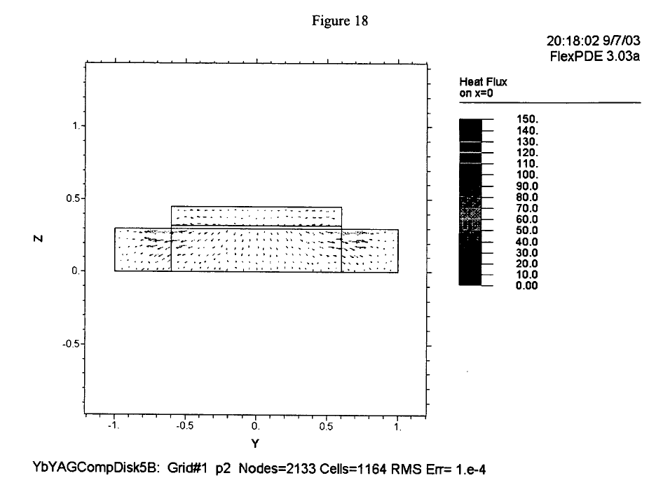

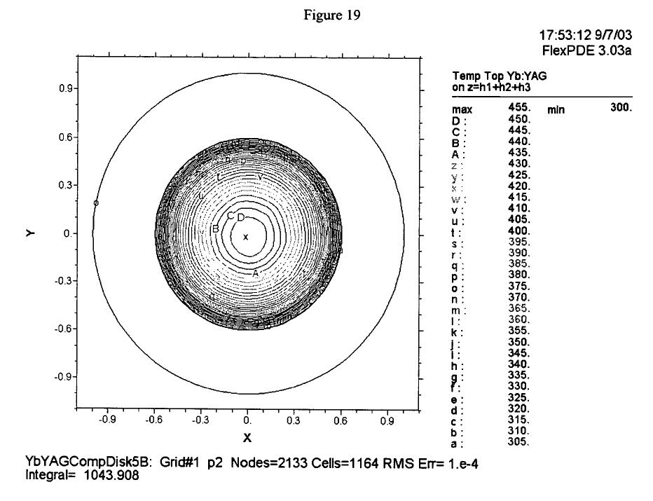

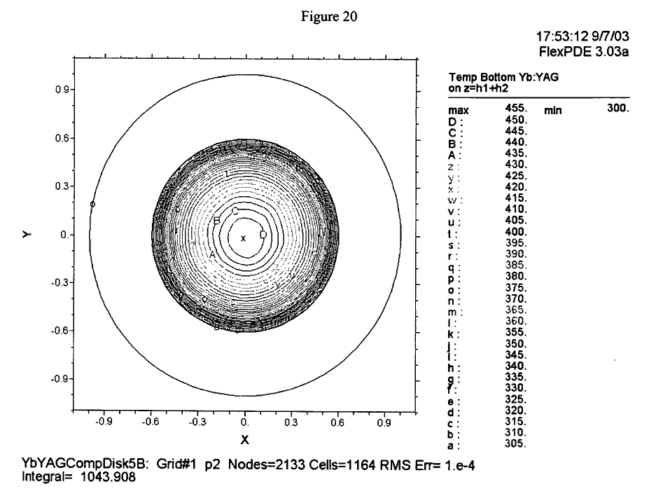

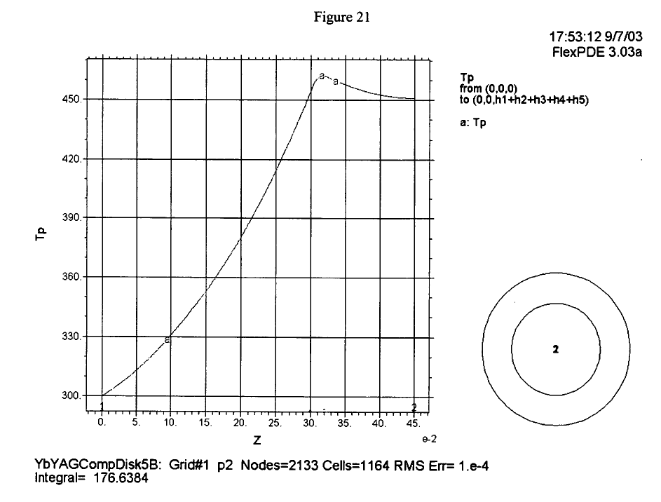

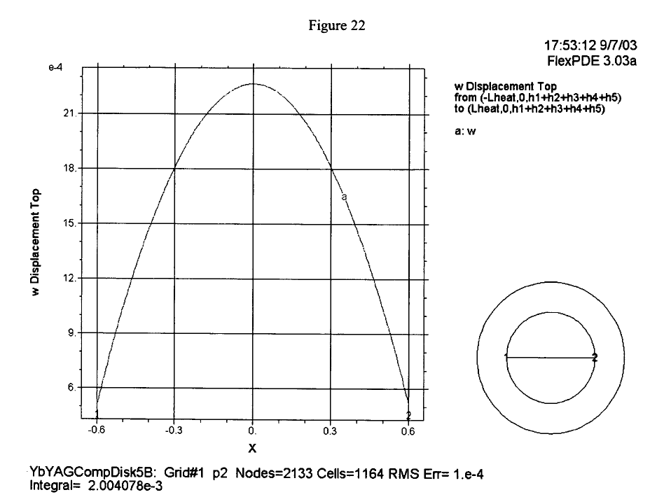

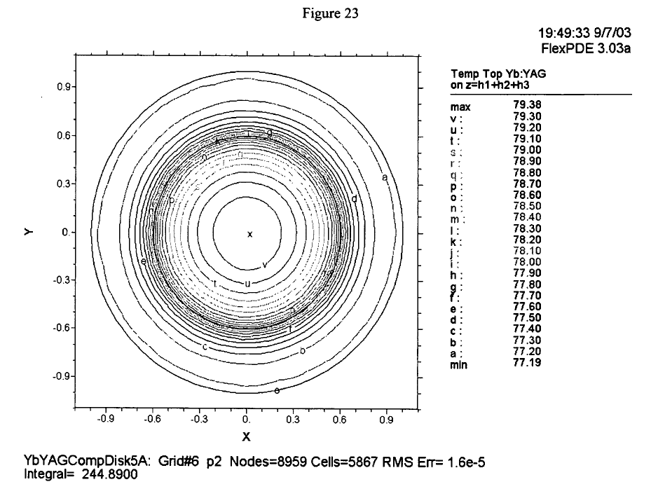

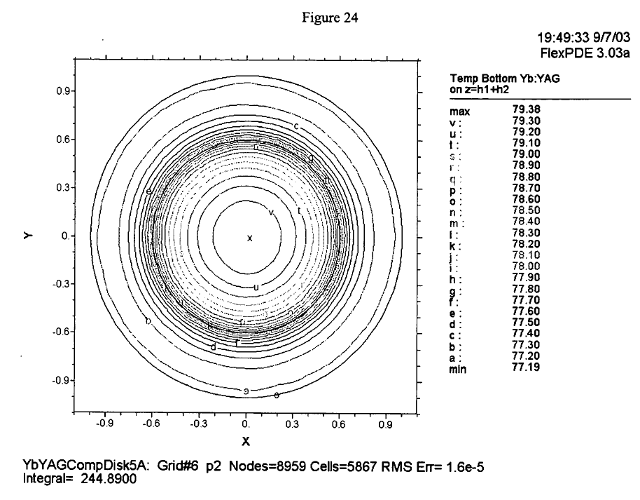

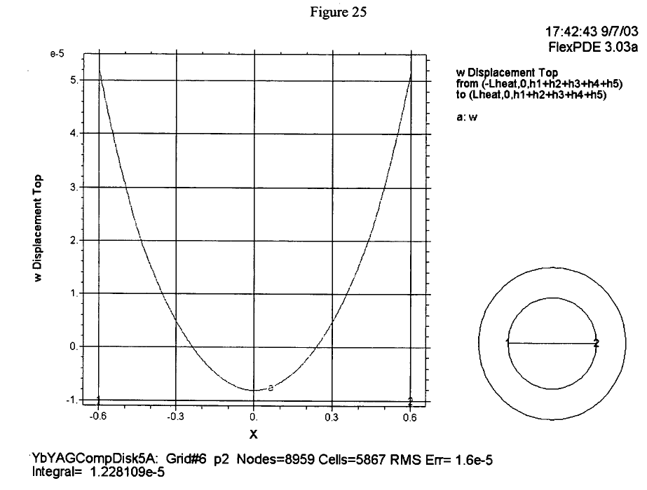

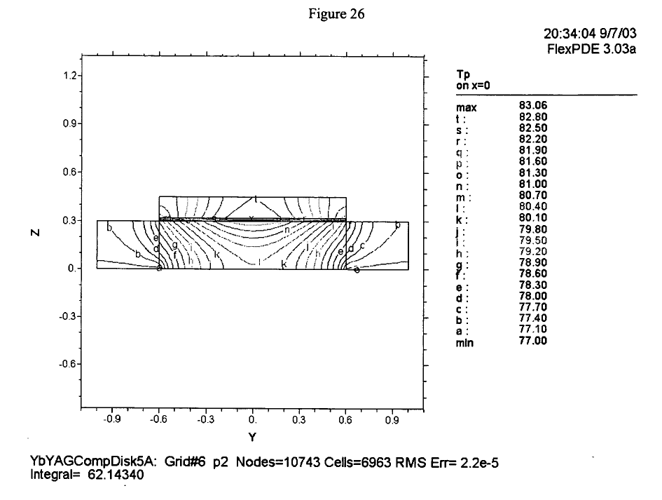

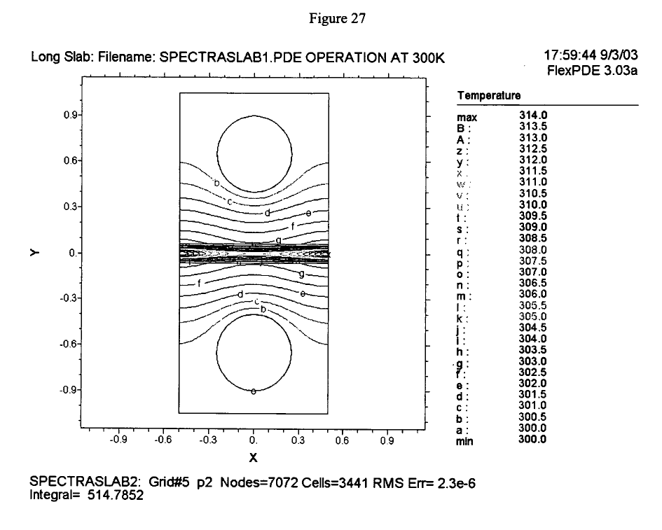

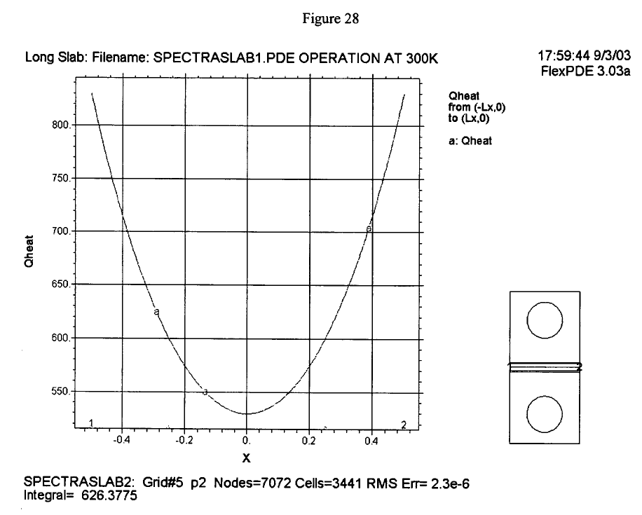

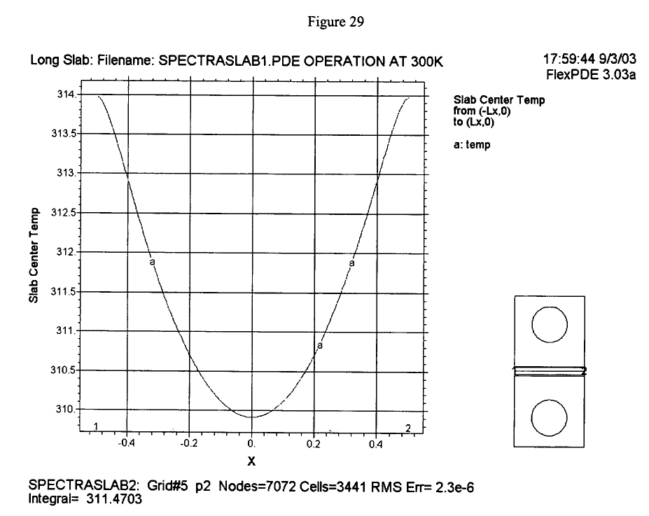

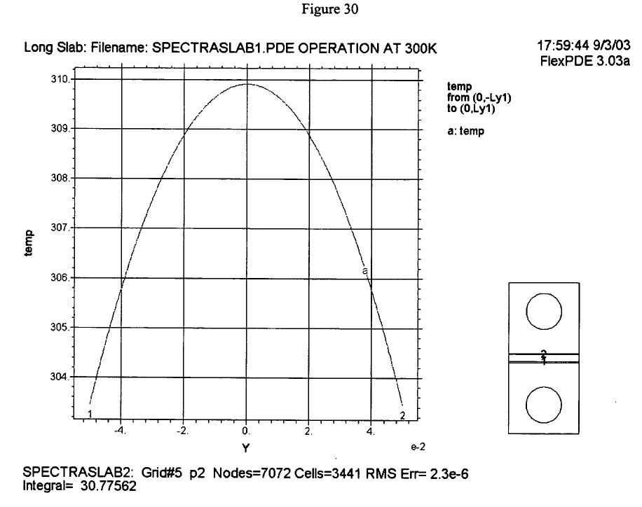

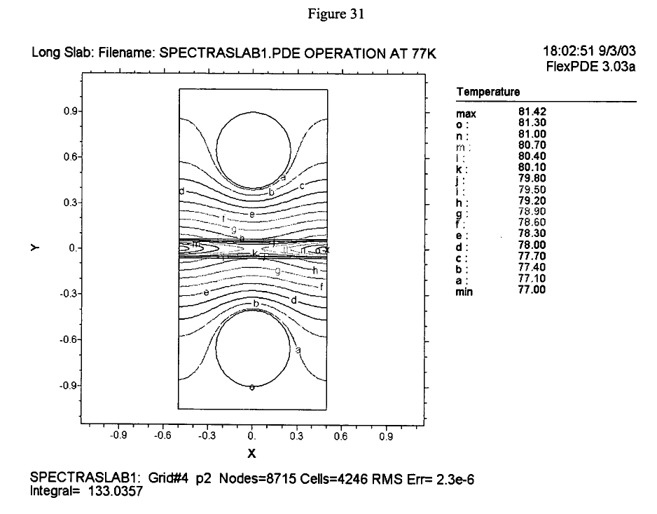

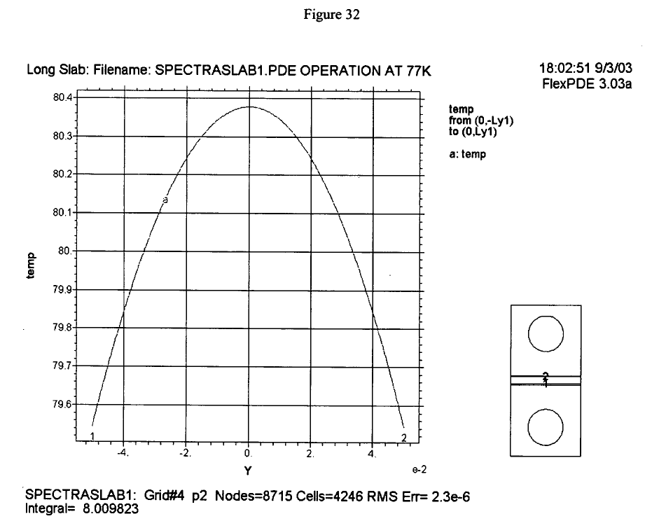

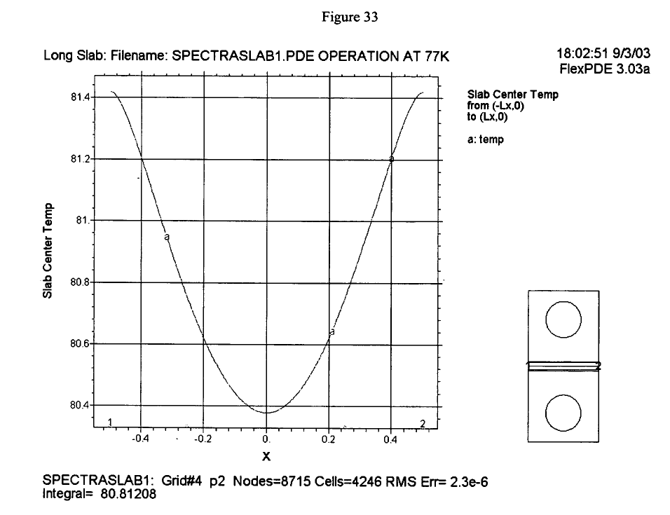

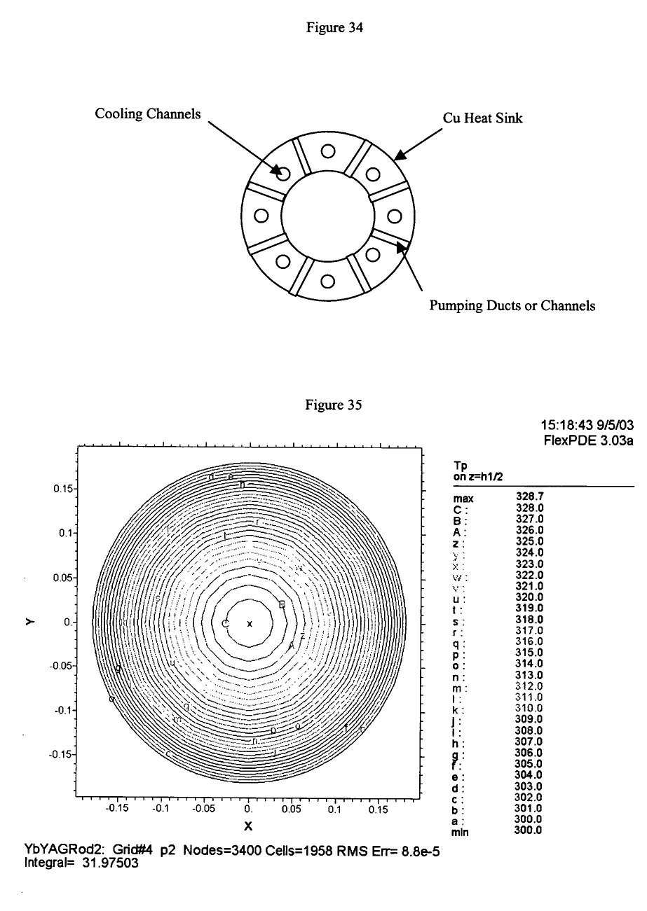

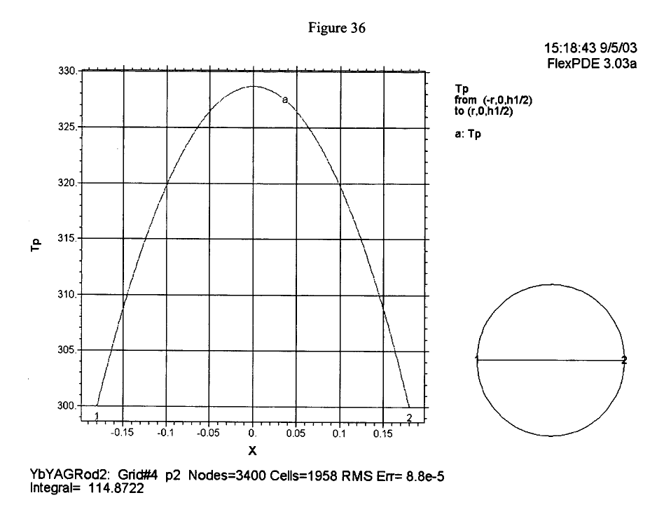

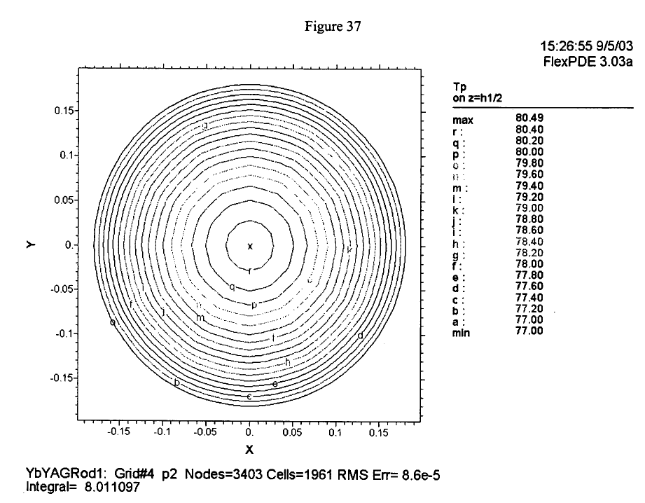

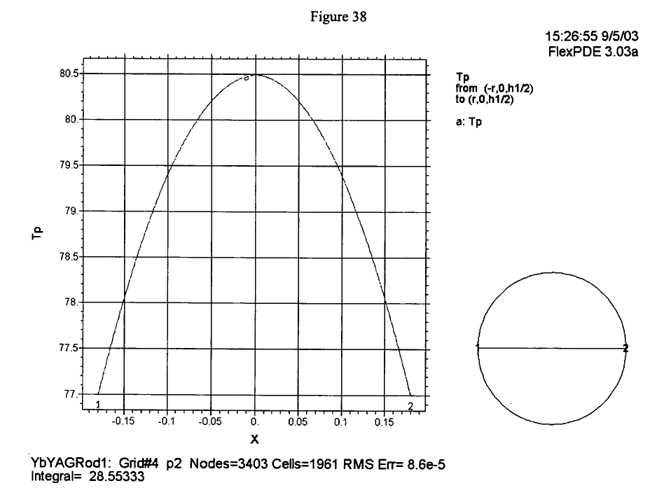

FIG. 7 shows an alternative embodiment of the conduction-cooled cryogenic solid-state laser. A composite or monolithic thin slab of laser material such as Yb:YAG or Nd:YAG is sandwiched between two highly conductive heat sinks through which a liquid cryogen is flowed. The cryogen channels may be conventional in nature or may involve microchannel cooling. In a typical configuration, the doped slab material is completely surrounded by another material that can be the undoped analogue of the doped material or may be a much higher thermal conductivity material such as sapphire. A soft material such as indium may be used to reduce stress between the slab and the cryogenically-cooled heatsinks, or between the doped slab material and the sapphire for example, to ameliorate stress caused by the difference between material expansion coefficients as temperature is cycled between cryogenic and room temperatures.

The slab is edge-pumped in this case, and the beam to be amplified emerges from the slab ends. Edge-pumping the slab is accomplished by using diode bars mounted on heatsinks that are cooled at or near room temperature. The diode bars may or may not have fast-axis collimating (FAC) lenses, and the slab may or may not have an evanescent or cladding coating applied to the top and bottom faces to aid in the trapping and absorption of the diode light by the slab. Simulations have shown that while this geometry leads to large transverse temperature gradients and thermally-induced lensing in both the thin and thick slab dimensions at room temperature, cooling the slab to cryogenic temperatures can for the most part eliminate the thermal lensing and any associated birefringence and result in very high average power output that can be near-diffraction-limited and leads to laser resonators and amplifiers whose output is substantially independent of average power. Unlike previous cryogenic laser designs where the cryogen fluid is in direct contact with the solid-state laser cooling surface, in this case the cryogen is circulated through an adjacent highly thermally conductive heatsink, resulting in a much reduced probability of thermally-induced fracture as temperature is cycled between room temperature and cryogenic temperatures.

A discussion and presentation of results obtained by modeling known laser configurations such as disks, slabs and rods, was provided in the related provisional application Ser. No. 60/505,054, incorporated by reference herein.

A. Thin Disk and Active Mirror Modeling

An example of a thin active-mirror amplifier shown in FIG. 8. There are two separate versions of this configuration, one in which the heat sink is opaque and in the other transparent. We discuss the opaque case first. The heat sink here might be a material like Cu which has a good thermal conductivity at room temperature that becomes even greater at 77° K. In many cases the thin disk placed on the Cu heat sink to manage the heat generated is a single thin Yb:YAG disk without the undoped regions on top and bottom as shown in FIG. 8. The disk is pumped either from the edge or is face-pumped. If the disk is face-pumped it can only be pumped from the top face since the heat sink is opaque; this necessitates extracting the disk with a beam that makes a finite angle with the normal to the disk face as show by the dotted lines in FIG. 8. If the disk is edge-pumped, however, extraction can be parallel to the disk normal.

To extract the heat generated in the disk, many methods can be used and have been proposed, and all involve removing the heat in the direction normal to the disk and through the heat sink. In the ideal case where the disk is uniformly pumped and the heat generated is uniform and the top face and edges are insulated (typically by air at room temperature), the heat is removed in a direction that is parallel to the disk face normal and a thermal gradient exists in that direction only (there is no radial temperature variation). In this case, which is the face-pumped laser case treated previously, if the extracting beam is parallel to the disk normal no net thermal distortion exists since each ray in the beam experiences the same total thermal environment. In fact, for this active-mirror configuration rays that are traveling off axis as shown in FIG. 8 also experience the same total thermal environment and there is no net thermal distortion in that case either (although some beam vignetting occurs at the disk edges). These observations apply to the bulk thermal effects. In reality, phase distortion can also be impressed upon a beam by the strain-induced distortion of the top and bottom disk faces, which bend due to the temperature gradient between the top and bottom faces. This distortion can also occur if the disk is non-uniformly pumped by a Gaussian like or radially intensity dependent beam. To avoid these strain-induced distortions, one can bond (for example using diffusion bonding) a clear YAG disk to the top and bottom faces of the Yb:YAG disk as shown in FIG. 8. A material like sapphire may also be used at room temperature however for operation over a wide temperature range all three disks should be fabricated from the same material to minimize differential thermal expansion. Also, sapphire may only be diffusion-bonded to YAG in a preferred orientation which can lead to birefringence issues if crystal orientation is not considered.

In the transparent case, the heat sink material could be sapphire, which is the case we report on here. Sapphire has a good thermal conductivity at room temperature and very good conductivity at 77° K. Two further cases can be considered here. The first is where the sapphire has the same diameter as the Yb:YAG disk and the second case where it is significantly larger. We will consider both here. In the transparent case the cooling of the sapphire must be accomplished by placing the cooling fluid near to or in contact with the sapphire heat sink edge or bottom face. In many cases it is very desirable to pass the extracting beam through the entire thin disk/heat sink assembly as shown in FIG. 19. This single pass arrangement can be contrasted with the normal active-mirror configuration where an extracting beam is reflected off the HR coating of the bottom disk face (or the bottom face of the undoped YAG) and the amplifier is intrinsically double-passed. Since in general it is not desirable to pass the beam through a cooling fluid the sapphire bottom face must be un-cooled where the beam passes through. This necessitates using edge cooling or cooling of the bottom sapphire face outside of the region where the beam passes through. This cooling method imparts a radial phase distortion of the beam which can be large at room temperature but can be for the most part eliminated or reduced to a residual effect at 77° K.

Here we examine where the heat sink is opaque, and we have chosen to use sapphire. We examine two cases each, at 300° K and 77° K; we used the thermal conductivity fit shown in FIG. 9 for the FlexPDE simulations. In previous work, two disks were used, a bottom Yb:YAG disk and a top clear YAG disk in a classic active-mirror configuration. The top undoped disk is used to minimize strain-induced bending of the Yb:YAG top and bottom faces. The bottom disk face was coated to be HR at the Yb:YAG operating wavelength (1029 nm) and was overcoated with a Au layer that was soldered to a heat sink with In. The disk top face was AR coated at 1029 nm. Microchannels were placed in the heat sink to minimize the thermal resistance between the coolant and the thin disk; the thin layers of Au and In added only minor thermal resistance to the package. Recall that minimizing the Yb:YAG temperature also minimizes the Yb terminal level thermal population and thus minimizes the wasted transparency pump power. The 200 μm thick Yb:YAG disk was 1.2 cm in diameter, and the clear YAG top disk was 1.3 mm thick and the same diameter (we ignore the angled edges used in [11,12]). The disk was pumped using 15.6 kW of pump power at 941 nm using beam ducts. We have done 3-D modeling of this disk using FlexPDE and now review the results. We assumed in all the modeling that from reported literature values the heat fraction was 0.11. Again, because the exact cooling method is not important to the conclusions presented here, we also assumed that the cooled surfaces of the heat sink are maintained at the coolant temperature. The sapphire heat sink examined here has a thickness of 3 mm; as will be seen, at room temperature the heat sink itself adds significant thermal resistance and raises the Yb:YAG temperature, while at 77° K the heat sink resistance is minimal. The heat sink thermal resistance at room temperature can be minimized by using aggressive, albeit expensive and high-pressure microchannel cooling techniques. Operating at 77° K however minimizes the advantages offered by microchannel cooling although in some cases LN₂ can also be used as an attractive coolant in microchannel coolers.

Case 1: Thin Yb:YAG Disk With Sapphire Heat Sink and Cooling at 300° K:

We first present results from operating a Yb:YAG thin disk at 300° K and with a sapphire heat sink whose diameter is equal to that of the Yb:YAG disk and when the entire bottom heat sink face is held at constant temperature. The geometry is show in FIG. 10. The temperature contours are shown in a cut through the center of the disk in FIG. 10. The temperature rise from the bottom of the heat sink to the maximum in the undoped top YAG disk is 605° C. Also note that the contours are all parallel, indicating that the heat flow is uni-directional out of the Yb:YAG disk into the sapphire and then is ultimately removed by a cooling fluid at the bottom of the heat sink. This is confirmed in FIG. 11 where the heat flow is shown and with each arrow indicating the heat flow direction. In FIG. 12, the temperature is shown at each point in the center of the disk/heat sink assembly and one may ascertain the temperature rise in the sapphire, Yb:YAG disk, and the undoped disk. The rise in the sapphire is about 295° C., the Yb:YAG disk about 8° C., and the clear YAG about 2° C. The sapphire heat sink contributes such a large temperature rise because of it's relatively low thermal conductivity at room temperature. This temperature rise can be nearly eliminated by placing microchannel cooling channels in the sapphire (or any other heat sink material) just beneath the sapphire surface in contact with the Yb:YAG disk bottom surface. The temperature drop across the Yb:YAG disk and the undoped YAG is a modest 10° C., which means that the quasi-three-level nature of the Yb:YAG disk is not significantly worsened by disk heating if microchannel cooling is used. Other obtained results (not shown here) indicate that the disk stress levels are very high, and at a significant fraction of the fracture stress of Yb:YAG. This conclusion is confirmed by the large amount of face strain distortion seen at the top face of the undoped YAG disk and shown in FIG. 13. Over 30 μm of distortion is obtained between the center and the edge of the disk both on the top of the clear YAG disk and the bottom of the Yb:YAG disk; these equivalent lens type distortions are partially correctable.

These results show that the thin disk is capable of operation as a face-pumped laser with little or no bulk thermal distortion if uniform pumping of the slab is achieved; the average disk operating temperature can also be minimized to −10° C. by using microchannel cooling. The stress and strain levels obtained however are problematical both from a thermally-induced fracture and strain-induced face absorption point-of-view.

Case 2: Thin Yb:YAG Disk With Sapphire Heat Sink and Cooling at 77° K:

If however the same disk/heat sink assembly is cooled to 77° K, rather different results are obtained. FIG. 14 shows the temperature contours for the same laser amplifier and again the contours are all parallel indicating operation as a face-pumped laser. The entire temperature rise is now only 3.9° C.; FIG. 15 indicates that about 2.65° C. of the 3.9° C. temperature rise is a result of the thermal resistance of the sapphire heat sink. The temperature rise is only about 1.25° C. in the Yb:YAG and undoped YAG disks, and because the average temperature is only a few degrees above LN₂ temperature, the Yb:YAG laser material acts like a four-level laser. In this case the stress and strain levels are residual, thus thermally-induced fracture is not an issue. Even with such a large thermal loading (the heat power density is about 5058 W/cm³ in both cases), FIG. 16 shows that the strain distortion at the top face of the undoped disk and the bottom surface of the Yb:YAG disk is only 0.65 μm. These examples again point out that the use of cryogenic cooling for solid-state laser materials results in dramatic improvement in system performance. Even in this case where the pump power is extreme and suitable for producing very high average power solid-state lasers (especially when a number of identical or like amplifiers are used), the benefits are overwhelming.

Case 3: Thin Yb:YAG Disk With Wide Sapphire Heat Sink and Cooling at 300° K:

Here, we widened the 3 mm thick sapphire disk to 2 cm. This results in the situation where the heat flux is not completely parallel to the disk normal. As shown in FIG. 17 however, the maximum temperature is reduced when compared to Case 1 because the larger sapphire volume results in less thermal impedance. FIG. 18 shows the direction of the heat flux and it can be observed that some of the heat flux moves transversely into the sapphire region with diameter greater than the Yb:YAG disk. This transverse flux is what is responsible for the flux lines no longer being parallel. Because every ray passing through the and clear Yb:YAG disks does not see the same total thermal environment, there is now a radial varying phase across a beam after exiting the amplifier. It is remarkable however that the temperature distributions on the top and bottom Yb:YAG faces are almost identical (see FIGS. 19 and 20). In FIG. 21 it can be seen that here also the majority of the temperature rise occurs in the sapphire heat sink, about 155° C., and this temperature rise can be eliminated by microchannel cooling. FIG. 22 shows that the strain distortion of the top clear YAG and bottom Yb:YAG faces is severe, due to the large stress and strain levels found in the design.

Case 4: Thin Yb:YAG Disk With Wide Sapphire Heat Sink and Cooling at 77° K:

In this case, the same geometry and Case 3 is treated, however now the coolant temperature is reduced to 77° K. As with previous cases, the maximum temperature rise is very small, about 3.6° C., whereas in Case 2 it was 3.9° C. This crystal assembly also develops a radial variation in temperature and a resulting radial phase profile, however now the radial variation is very small. FIGS. 23 and 24 show the temperature contours at the top and bottom of the Yb:YAG disk, and they are virtually identical. The sapphire temperature variation is almost the same. The center-edge temperature variation is 2.19° C. and taking the dn/dT value at 77° K and using the Yb:YAG thickness of 0.2 mm, we find that the number of waves distortion from the center to the edge is only 3.5×10⁴ waves at 1029 nm. The maximum number of waves distortion for the 1.3 mm thick clear YAG portion of the assembly is then only 2.3×10⁻³ waves. For sapphire, dn/dT also decreases with temperature, and is less than 2.8×10⁻⁶/° K for sapphire whose C axis is parallel to the beam propagation direction. For the 3 mm thick sapphire disk, the maximum number of waves distortion would be 1.79×10⁻² waves. This value can be further reduced by changing the sapphire disk thickness. For the entire crystal assembly, the number of waves distortion is then less than 2.05×10⁻² waves, which is very small indeed for the amount of pump power the small crystal assembly is handling. FIG. 39 shows that the strain-induced face distortions are also very small.

Case 5: Thin Yb:YAG Disk With Wide Sapphire Heat Sink and Cooling at 77° K (Heat Sink Bottom Face Partially Cooled):

The last Case we present is where the bottom face of the sapphire crystal is not uniformly cooled at 77° K. As shown in FIG. 40, the bottom face diameter equal to the Yb:YAG disk diameter is insulated (in air or vacuum), while the disk face area outside the central un-cooled area is actively cooled and the temperature held constant at 77° K. This geometry mimics the practical situation where the outer region of the bottom sapphire face is in contact with a cooled heat sink (which could be Cu for example, or the sapphire itself could contain cooling microchannels), and the amplifier itself allow the straight-through propagation of a beam to be amplified. In this configuration the beam does not pass through a cooling fluid.

Here, FIG. 26 shows that the maximum temperature rise is still very low, only about 6.06° C. FIGS. 42 and 43 show that in this case also the radial temperature profile is constant, with about a 4.45° C. difference between the center and edge of the Yb:YAG crystal. The total number of waves distortion in the crystal assembly in this Case is about double that of the previous Case, or 4.1×10⁻² waves. Here again the amount of distortion can be further reduced by optimizing the thickness of the sapphire disk. Since this distortion is still comparable to the intrinsic passive phase distortion found in laser materials, we conclude that amplifiers built along the principles discussed here will enable major improvements in the performance of high-average-power solid-state lasers. It should also be emphasized that the geometry shown here is ideal in the case one wants to build linear optical resonators. Allowing the beam to pass through the crystal assembly rather than being reflected in the active-mirror configuration enables the laser designer to construct periodic resonators for example where thin disks of the type shown here can be placed at strategic locations. Scaling up of the laser average power can then proceed by either increasing the number of disks and by adjusting the thin disk diameter. High-average-power single aperture oscillators or oscillator-amplifier systems can be constructed with ultra-high-average-power output.

B. Slab Amplifier:

The channels can be used to carry common fluids like water or an ethylene glycol/water mix for operation near room temperature or perhaps down to −30° C. For cryogenic operation however LN₂, liquid air, or any other cryogenic fluid can be used. With this geometry, the cryogenic cooling fluid does not need to be transparent to the pump light.

For the thin slab approach, pumped from the side, he amount of pumping is limited by the thickness of the slab and the brightness of the diode array used. Nevertheless, a number of practical designs can be realized using this approach. The thickness of the slab is usually chosen so that single-mode output can be obtained; for this the slab thickness must be in the typical range of 0.5-2 mm where common resonators with reasonable mirror separations and radii of curvature can be employed to produce stable lasers. Another attractive feature of the design shown in FIG. 4 is that the slab transverse dimension rather than the thickness dimension determines the doping level needed to efficiently absorb the pump light. Because of the high aspect ratio of a typical slab of this design, the doping density needed is reduced and this can decrease the thermal loading and help insure good optical quality in the slab.

The differential thermal expansion between YAG and Cu or sapphire can be a problem with this design, particularly when cooling to low temperature. To avoid significant stresses, a material such as indium or an elastomer is deployed as a thin layer between the slab material and the heatsink. Even at low temperature those materials maintain some elasticity and can be used to relieve stress buildup.

As mentioned in the previous discussion, Cu and sapphire are particularly attractive as heat sink materials. Cu is the most resistant to thermal shock and can be used with good success.

When cooling from room temperature to LN₂ temperature it can be seen that the already large (compared to typically crystalline material thermal conductivity at room temperature) thermal conductivity increases from around 4 to ˜5.7 W/(cm-° K), an increase of 1.40. For sapphire, the same data is shown in FIG. 6; while the available data is sparse it is clear that the value of the sapphire thermal conductivity increases from about 0.3 W/(cm-° K) at room temperature to about 11 W/(cm-° K) at 77° K, an increase of almost 37 times.

In order to illustrate the benefits of cryogenically-cooling the slab, we now compare detailed thermal modeling of the design described in the U.S. patent application to Hodgson et al. The slab was fabricated from Nd:YAG with 0.8 at −% Nd doping. The heat fraction for this doping is about 0.35; the slab was 1 cm wide and 9 cm long, and was pumped in the center 7 cm long region with six 1 cm long diode bars per side and with each bar producing a maximum of 60 W. The total pump power was then 720 W. The diode bars were coupled into the slab along the thin edges and produced a hyperbolic cosine absorption distribution in the slab transverse direction; about 85-90% of the incident diode light was absorbed. The heat sinks on the top and bottom of the slab were Cu and cooled with water at room temperature; a thin layer of indium was placed between the Cu heat sinks and the slab. The slab edges and ends were in air and thus effectively insulated.

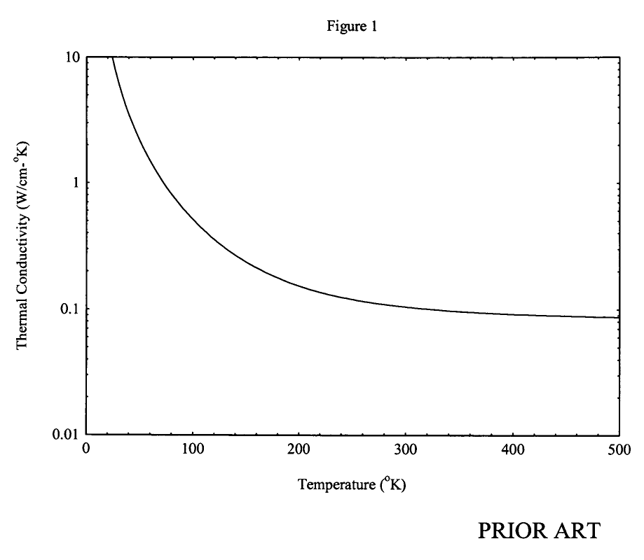

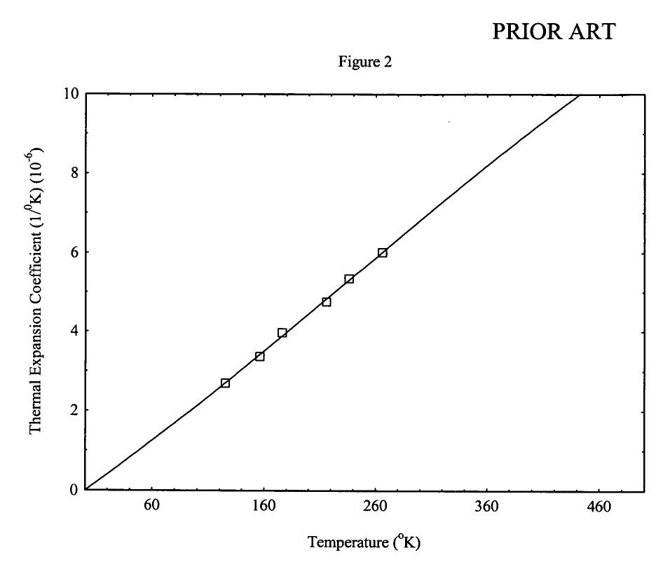

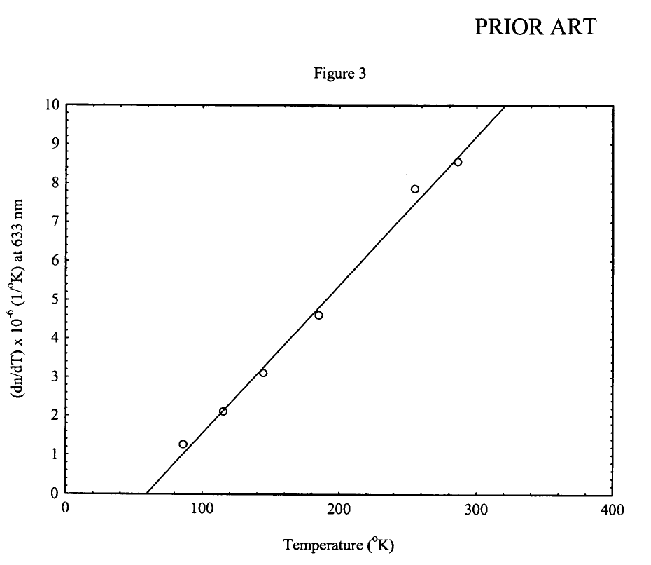

We now compare the thermal performance expected at room temperature and 77° K, determined by using the finite-element program FlexPDE; in this modeling all parameters of interest are assumed to vary with temperature according to the fits shown in FIGS. 1, 2, and 3, for the thermal conductivity, linear thermal expansion coefficient, and dn/dT respectively. The fits cover the entire temperature range of interest here. In FIG. 27 we show the CW thermal profile in a 2-D cut through the center of the laser. The maximum temperature rise is about 14° C. and occurs at the slab edges where the maximum pumping occurs. In FIG. 8 we show the heat density Q (W/cm³) in the transverse direction (x) in the slab and the profile is approximately hyperbolic cosine. The value of Q varies from about 530 W/cm³ in the center to about 830 W/cm³ at the slab edges. This transversely varying heat density profile is partly responsible for the non-uniform transverse temperature distribution shown in FIG. 10; the variation from slab center to edge is seen to be about 4.2° C. Part is also due to the simple cooling channels employed; widening and using rectangular channels and locating them closer to the slab would result in an improvement in the transverse temperature variation and a reduction of the slab mean temperature. In FIG. 9 we show the temperature variation in the slab thickness (y) dimension where in the center of the slab the variation is about 6.5° C. If we ignore stress-induced changes in index of refraction, which is a good approximation here because the stress levels are low, we can calculate the number of waves distortion associated with the aforementioned temperature differences from the relationship

$$N = \frac{1}{λ} β L Δ T , \qquad ( 1 )$$

where λ is the laser wavelength (here 1064 nm), L the slab pumped length, α=dn/dT the change in index with temperature (9.35×10⁻⁶ at 300° K), and ΔT the temperature difference. Using equation (1), we find that for the slab modeled here there are 2.58 waves and 4.0 waves of distortion in the slab transverse and thin dimensions respectively.

The same configuration was modeled for low temperature operation by setting the cooling fluid to a temperature of 77° K. The resulting temperature profiles are shown in FIG. 11; it should be noted that the temperature deltas in both the transverse and thin dimensions are significantly smaller. As shown in FIGS. 12 and 13, the maximum temperature differentials in the transverse and thin dimensions are 0.81 and 1.06° C. At 77° K however, α is much smaller, about 0.83 ×10^{-6/° C., and thus the number of waves distortion in the transverse and thin dimensions are} 0.06 and 0.04 waves respectively. The stresses in the slab at 77° K are residual and there is no strain distortion of the flat slab end faces through which the beam must pass.

To conclude this discussion, in a slab cooled to the vicinity of 77° K can be designed to display only residual thermal distortions, in this case in spite of the fact that there is a large transverse variation in the heat load. This discovery means that distortion-free solid-state lasers can be built with only a modest increase in system complexity. High-average-power solid-state lasers can now be built whose performance is not limited by thermal effects; optical resonators can now be built whose output characteristics are for the most part independent of average power. The beam size, divergence, and mode content of cryogenically-cooled solid-state lasers will be invariant to average power level. This approach solves a long-standing obstacle to scaling up solid-state lasers into the hundreds of kW to the MW power regime, and will improve the performance of all solid-state lasers at any output power level.

Finally, it should be pointed out that the design we modeled here and shown in FIG. 4 is relatively simple and straightforward. In the spirit of this invention, however, we point out that more sophisticated cooling methods or implementations should not change the fundamental conclusions pointed out here. Regardless of the specific cooling method used to achieve it, operating solid-state lasers in the cryogenic regime as defined in this patent will result in many positive benefits which include much better thermal conductivity and reduced temperature gradients, a reduction in the thermal expansion coefficient, a concomitant reduction in the elastic stresses and strains, and a dramatic reduction in dn/dT. These effects have a most beneficial effect on laser performance since slab stresses and strains are substantially reduced and the wavefront distortion reduced to values comparable to the intrinsic variations found in commercial laser materials.

We mention in passing that some of the other alternative cooling methods we have considered and modeled are the use of microchannel coolers using LN₂ or cool nitrogen gas, the use of other cryogenic fluids and gases including those not mentioned in this application, the use of spray coolers, Joule-Thomson cooling, Stirling coolers, Gifford-McMahon coolers, Kleemenko coolers, CHIC coolers that use cryogenic fluids or gases, and others. Cooling systems may be either open or closed cycle.

B. Rod Amplifiers:

It should be obvious that the discussion in the previous section A. regarding slab amplifiers applies to other solid-state laser amplifier geometries as well. In fact we have not found a case where cryogenic cooling is not a benefit. Rod amplifiers (right circular cylinders of laser material) have also been examined and here we review one specific case. We considered a rod of Nd:YAG laser material, and assume a length of 7 cm. We take the rod face area to be equivalent to that of the slab examined in Section A, 0.1 cm², and thus set the rod diameter at 3.6 mm. The heat fraction is again 0.35 and the total pump power is 720 W. This results in a heat power density of 360 W/cm³, which we assumed was uniform throughout the rod volume. The rod is assumed to be encapsulated along it's length by a Cu heat sink and a thin layer of In between the Cu and the rod. The geometry is shown in FIG. 14. The rod could be either end-pumped or transversely (side) pumped. In the case of end-pumping there are no restrictions on where the cooling channels are placed in the Cu heat sink, in fact the cooling could be provided by a sheath of coolant. For side-pumping however the cooling channels must be placed between the through channels or ducts where the diode array light is introduced into the rod. Other pumping methods are possible also, for example fibers could be used to introduce the diode light. Alternatively the heat sink could be made out of a transparent materials like sapphire which as we have seen is a very good choice, and the diode light transmitted directly to the rod between the cooling channels.

For the purposes of illustrating the benefits of cryogenic cooling, we consider the case where the entire rod barrel is uniformly cooled, since again the cooling method is not important, only the net benefit of reducing the thermal effects in the rod. Adding a heat sink with some finite thermal resistance will not change the conclusions presented here, only slightly elevate the temperatures but not change the radial distribution. In FIGS. 15 and 16 we show a contour plot and then an X-Y plot of the radial temperature distribution in the rod with cooling at room temperature, as determined using a 3-D FlexPDE finite-element model. The temperature at the rod edge was maintained constant at 300 ° K and the YAG thermal conductivity and thermal expansion coefficient were functions of temperature. It can be seen that the temperature difference between the center and edge of the slab is about 28.5° C.; the wavefront distortion then amounts to 17.53 waves. The net strain distortion at the rod ends is not severe but still amounts to about 0.4 μm at each end of the rod. In FIGS. 17 and 18, we show the same plots but with the coolant temperature reduced to 77° K. In this case the center-edge temperature difference is reduced to about 3.49° C. and the number of waves distortion drops to only 0.19 μm. As expected, because the stress and strain levels at 77° K are so low, the strain distortion of the rod end faces almost vanishes and is only about 0.01 μm.

As was shown previously with the slab laser, for an equivalent rod laser amplifier we observe the same dramatic reduction in the transverse distortion, and a drop in the strain and stress levels that render the rod ends virtually distortion free. It can thus be seen that the benefits of cryogenic cooling can significantly improve the performance of rod amplifiers as well.

In this disclosure we have shown the benefits that can be obtained by lowering the operating temperature of common solid-state lasers from near room temperature to the cryogenic regime. Regardless of the pumping method used, or the specific cooling system used, solid-state lasers benefit enormously from operation at lower temperatures. These improvements are obtained for both the thermo-optical-mechanical properties and the laser-spectroscopic properties. While in this application we have concentrated on cooling with LN₂, and the use of sapphire and YAG optical materials, clearly other materials and coolants may be used. It is worth mentioning here for example that the thermal conductivity of Type I diamond is equal at room temperature to that of sapphire at 77° K (about 11 W/(cm-° K)). If diamond is cooled to 77° K a further large increase in thermal conductivity to 35 W/(cm-° K) is obtained. Artificially grown optically clear diamond is becoming increasingly available and will undoubtedly make further improvements in the types of amplifiers described here in the near future. The amplifier configurations discussed here can also be applied with success to realizing high-average-power and high-peak-power Ti:Sapphire terawatt and petawatt laser systems. In this case both the laser disk and the heat sink can be built from sapphire and each will have a much larger thermal conduction at cryogenic temperatures.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention of the entire laser source. Expected variations or differences in the results are contemplated in accordance with the objects and practices of the present invention.

What is claimed is:

1. A cryogenically cooled laser system, comprising:
a laser gain medium pumped by radiation from diode arrays and connected to a heat sink,
wherein the heat sink is cooled to cryogenic temperatures

2. The system of claim 1 wherein said laser medium is configured as a thin disk

3. The system of claim 1 wherein said laser medium is configured as a thin slab
